(19) United States
(12) Patent Application Publication
(10) Pub. No.: US 2010/0313393 A1
(43) Pub. Date: Dec. 16, 2010

(54) BALL PAPER CLIP DEVICE

(75) Inventors: Tae-Wan KIM, Seoul (KR); Jae-Ryong BUM, Seoul (KR)

Correspondence Address: GREENBLUM & BERNSTEIN, P.L.C., 1950 ROLAND CLARKE PLACE, RESTON, VA, 20191, US

(73) Assignee: Tae-Wan KIM, Seoul (KR)

(21) Appl. No.: 12/559,830

(22) Filed: Sep. 15, 2009

(30) Foreign Application Priority Data
Jun. 16, 2009 (KR) 20-2009-0007772

(51) Int. Cl. B42F 1/04; B42F 1/02

(52) U.S. Cl. 24/67 R

(57) ABSTRACT

The present invention relates to a ball paper clip for holding together two or more sheets of paper as using a ball. A clip ball is fitted into a guide hole formed in a clip body, and the papers are inserted between the clip ball and a support plate, so that the papers are clamped due to a natural phenomenon that the clip ball moves toward the lower end of the guide hole by gravity. The clip body or the clip ball is constructed to generate magnetic force so as to hold wire clips or pushpins.

### BACKGROUND OF THE INVENTION

1. Field of the Invention

The present invention relates to a ball paper clip for holding together two or more sheets of paper as using a ball, and more particularly to a multifunctional ball paper clip, wherein a clip ball is fitted into a guide hole which is formed in a clip body. And the papers are inserted between the clip ball and a support plate, so the papers are clamped due to a natural phenomenon that the clip ball moves toward the lower end of the guide hole by gravity, and the clip body or the clip ball is constructed to generate a magnetic force so as to hold wire clips or pushpins.

2. Description of the Related Art

In general, a ‘paper clip’ is an office supplies for use in holding a pile of papers and manufactured in various forms by bending a metal sheet or a wire. A conventional paper clip product had been examined by referring to Korean Patent No. 0776059 ‘Clip for office use’. The conventional paper clip for office use shown in FIGS. 1 to 3 includes a clip main body 10, which is bent at its center such that both ends thereof are in contact resiliently and maintains a large distance difference as it goes from both the ends to the bent portion 12. The main body 10 has a triangular or pentagonal cross section.

Fixing loops 11a and 11b are formed in both surfaces of the main body 10 so that insertion protrusions 15a and 15b of a handle can be pivotally coupled thereto. The fixing loops 11a and 11b are notched or lanced prior to the main body 10 is bent. The handles 15 are compressed to make the clip main body 10 gap, the papers are inserted into the gap of the clip main body 10, and the handles 15 are released, whereby the papers can be clamped by the elastic force of the clip main body 10.

The conventional clip is provided only for office use because of low product quality. If a user wants to vertically hang the clip on a desk or partition, he/she should install an additional screw or hook on the desk or partition, which causes the user's inconvenience. In addition, a clamping mark remains on the paper. Moreover, since the paper clips make an office messy, it is necessary to prepare an additional keeping box.

### SUMMARY OF THE INVENTION

An object of the present invention is to provide a ball paper clip for holding together two or more sheets of paper as using a ball, and more particularly, to a multifunctional ball paper clip, wherein a clip ball is fitted into a guide hole which is formed in a clip body. And the papers are inserted between the clip ball and a support plate, so that the papers are clamped due to a natural phenomenon that the clip ball moves toward the lower end of the guide hole by gravity, and the clip body or the clip ball is constructed to generate a magnetic force so as to hold wire clips or pushpins.

The clip ball fitted between the upper guide plate and the support plate can be made of rubber. Therefore the papers are able to be held tightly.

According to an aspect of the present invention, there is provided a ball paper clip, which comprises a clip body including the upper guide plate and the lower support plate, the upper guide plate and the lower support plate of a bifold with a gap made between it, the upper guide plate and the lower support plate being open at one side thereof to define a gap portion and being connected to each other at the other side thereof, the support plate having at the end taperingly cut to form a taper surface; The hole bored through the guide plate is shaped as a shape of an inverted triangle with rounded apexes; and a clip ball fitted between the guide plate and the support plate so that an outer surface of the clip ball can be partially inserted into the guide hole, whereby the papers inserted into the gap portion can be clamped.

### BRIEF DESCRIPTION OF THE DRAWINGS

FIGS. 1 to 3 are views illustrating a conventional clip;

FIGS. 4(a) to 4(c) are exploded perspective views illustrating first to third embodiments of the present invention;

FIGS. 5(a) to 5(c) are assembled perspective views illustrating the first to third embodiments of the present invention;

FIGS. 6(a) to 6(c) are front views illustrating the first to third embodiments of the present invention;

FIGS. 7(a) and 7(b) are views illustrating an operating state of the third embodiment of the present invention;

FIGS. 8(a) to 8(c) are views illustrating operating states of the first to third embodiments of the present invention;

FIGS. 9(a) to 9(c) are views illustrating using states where pushpins or bent clips are collected through a ball paper clip of the present invention;

FIGS. 10 and 11 are views illustrating product designs according to the second embodiment; and

FIGS. 12 and 13 are views illustrating product designs according to the third embodiment.

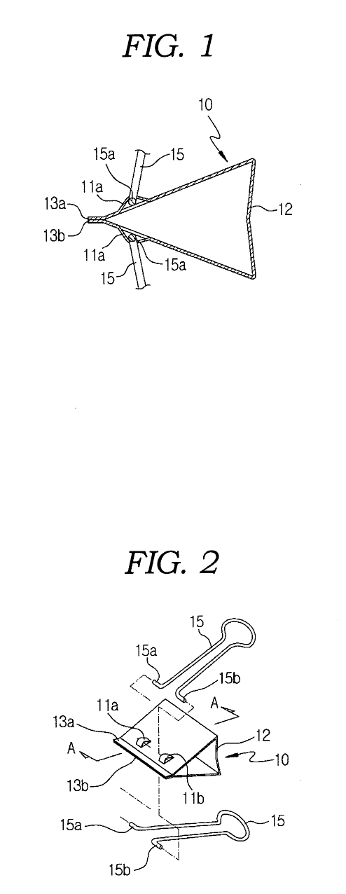

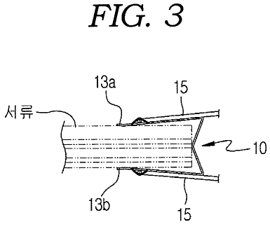

### DESCRIPTION OF THE PREFERRED EMBODIMENT

The present invention relates to a ball paper clip. The configuration and operation of the ball paper clip according to the present invention will be described in detail with reference to the accompanying drawings.

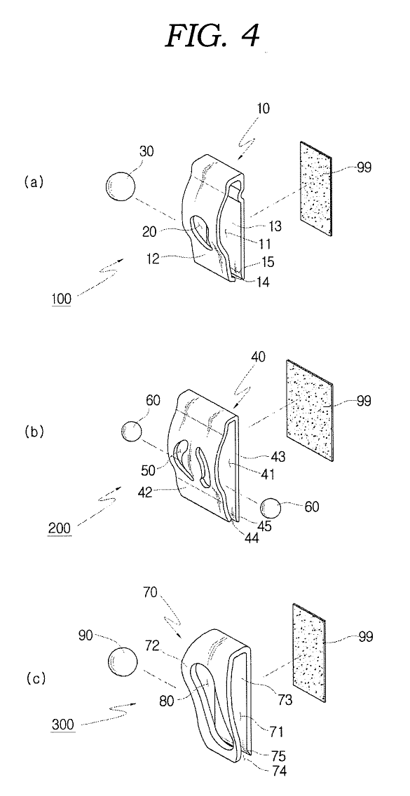

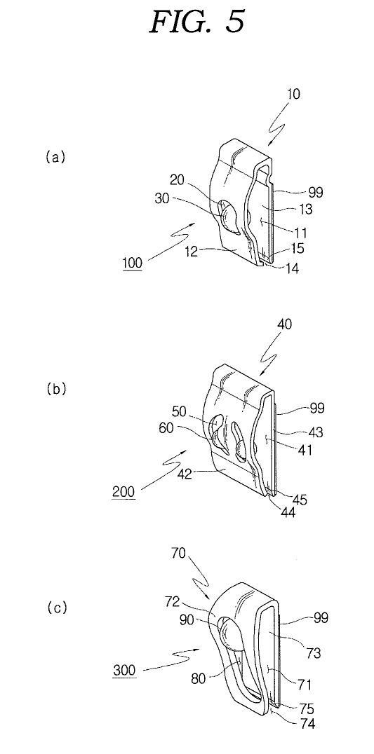

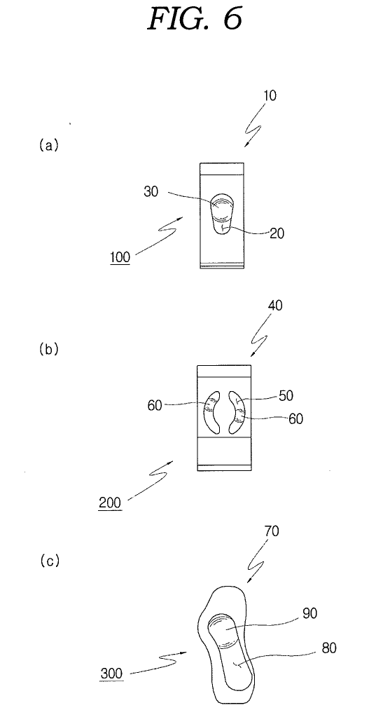

Three embodiments of the present invention are provided herein as shown in FIG. 4(a) to (c). A guide hole(s) 20, 50 or 80 is formed in a guide plate 12, 42 or 72 forming the upper portion of a clip body 10, 40 or 70, a clip ball(s) 30, 60 or 90 is fitted into the guide hole 20, 50 or 80, and paper is inserted between the clip ball 30, 60 or 90 and a support plate 13, 43 or 73. although these embodiments has the same principle in that the papers are clamped by the weight of the ball 30, 60 or 90 rolling down along the guide hole 20, 50 or 80, the embodiments are divided according to application forms of the principle.

The first embodiment is illustrated in FIG. 4(a). A ball paper clip 100 includes the upper guide plate 12 and the lower support plate 13 are consist of a bifold shape having a gap 11 made between it. The guide and support plates 12 and 13 are opened at one side thereof to define a gap portion 14 and are connected to each other at the other side. In the clip body 10, the end of the open support plate 13 is taperingly cut to form a taper surface 15, and the guide hole 20 is bored on the guide plate 12 vertically. The clip ball 30 is fitted such that the outer surface thereof may be partially inserted into the guide hole 20. Accordingly, the papers 35 inserted into the gap portion 14 are clamped.

The clip body 10 includes the guide plate 12 with the guide hole 20 formed therein and the support plate 13 formed integrally with the guide plate 12 at a lower end thereof. The clip body 10's shell can be manufactured in various forms. As shown in FIG. 4, the clip body 10 may have an automobile-shaped, or a softly rounded semicircular side. The guide hole 20 is formed in the guide plate 12 in the shape of an inverted triangle with a softly-rounded apex. The clip ball 20 is inserted into the gap 11 between the guide plate 12 and the support plate 13 such that an upper outer surface of the clip ball can be partially fitted into the guide hole 20. Thus, the length of the gap 11 is maintained to be slightly smaller than a diameter of the clip ball 30, so that a portion of the clip ball 30 can escape out of the guide hole 20.

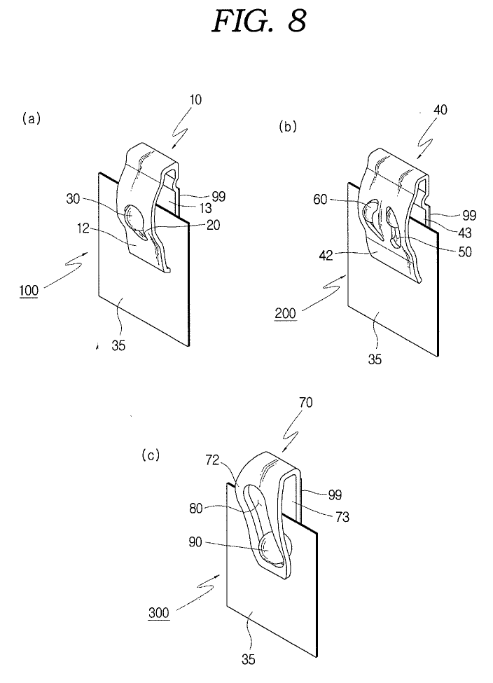

As shown in FIG. 8(a), this configuration makes it conveniently to insert paper into the ball paper clip 100 and hold the papers. When the paper 35 is inserted into the gap portion 14 of the clip body 10, the paper 35 is pushed toward between the support plate 13 and the clip ball 30. Here, the clip ball 30 is lifted upward by the insertion force of the paper 35, i.e., the clip ball 30 is lifted along the guide hole 20.

The ball paper clip 100 is normally suspended on the wall surface. The ball paper clip 100 is installed such that a lower end thereof, i.e., the gap portion 14 faces the ground. When the papers 35 are inserted into the gap portion 14, the clip ball 30 is lifted upward along the guide hole 20, the gap 11 between the clip ball 30 and the support plate 13 becomes wide at the same time, and the papers 35 are inserted thereinto. Thereafter, the clip ball 30 moves down along the guide hole 20 naturally by gravity, and the gap 11 between the clip ball 30 and the support plate 13 becomes narrow due to the weight of the clip ball 30, thereby to clamp the paper 35.

Here, the guide hole 20 is preferably formed in the shape of an inverted triangle. In this case, when the paper 35 is inserted, the clip ball 30 is lifted well such that the paper 35 can be inserted easily, and when the clip ball 30 rolls down, a fitting space of the outer portion of the clip ball 30 is reduced to accomplish the firm and close clamping. In addition, the taper surface 15 is preferably formed at the end of the support plate 13 such that the paper 35 can be easily inserted.

The second embodiment is illustrated in FIG. 4(b). A ball paper clip 200 includes the upper guide plate 42 and the lower support plate 43 are consist of a bifold shape having a gap 41 made between it. The guide and support plates 42 and 43 are opened at one side thereof to define a gap portion 44 and are connected to each other at the other side. In the clip body 40, the end of the open support plate 43 is taperingly cut to form a taper surface 45. The guide holes 50 bored through the guide plate 42 of the clip body 40 vertically are shaped as symmetrical semicircles and are spaced apart from each other at a certain interval. Also, the pair of clip balls 60 are fitted between the guide plate 42 and the support plate 43 such that outer surfaces of the clip balls may be partially inserted into the pair of guide holes 50, respectively. Accordingly, they cooperate with each other to clamp the paper 35 inserted into the gap portion 44.

The second embodiment is different from the first embodiment in the shape of the guide holes 50 formed in the guide plate 42. The guide holes 50 of the second embodiment are formed in the shape of semicircles which are symmetrical left and right as shown in FIG. 4(b). Since the two guide holes 50 are at the left and right sides of a guide plate, the two clip balls 60 are inserted into the guide holes 50.

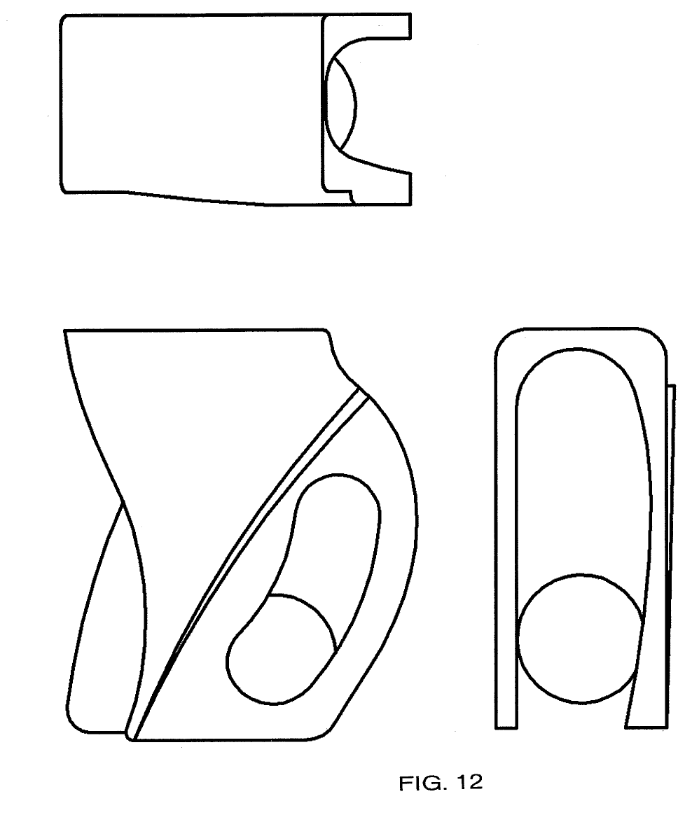

The operation thereof will be explained as shown in FIG. 8(b). When the papers 35 are inserted into the gap portion 44, an end of the paper 35 lifts the two clip balls 60, so that the gap 41 between the clip balls 60 and the support plate 43 becomes wide. The end of the paper 35 is inserted between the clip balls 60 and the support plate 43, and the clip balls 60 are rolled down at the lower part of the hole again, so that the paper 35 is clamped between the support plate 43 and the clip balls 60. Since the two clip balls 60 clamp the paper 35 on the left and right sides, they can firmly hold the paper 35 and easily maintain its balance. As a result, since the clip balls 60 can be reduced in size, it is possible to reduce the ball paper clip 200 in size or thickness. Examples of product designs according to the second embodiment are shown in FIGS. 10 and 11.

The third embodiment is illustrated in FIG. 4(c). The third embodiment is characterized in that a beautiful female figure is expressed to improve an aesthetic sense. In terms of function, the guide hole 80 with curves is used to ensure firmly clamping.

A ball paper clip 300 includes the upper guide plate 72 and the lower support plate 73 of a bifold, and they are opened at one side thereof to define a gap portion 74 and connected to each other at the other side thereof. A part of the end of the open support plate 73 is taperingly cut to form a taper surface 75. The clip body 70 is shaped such that its planar external shape is a female figure with curves, and the guide hole 80 bored through the guide plate 72 of the clip body 70 vertically is shaped as a shape of a softly-rounded curve and declining toward one side from the upper guide's center axis. The clip ball 90 is fitted between the guide plate 72 and the support plate 73 such that an outer surface of the clip ball can be partially inserted into the guide hole 80. They cooperate with each other to clamp the paper 35 inserted into the gap portion 74.

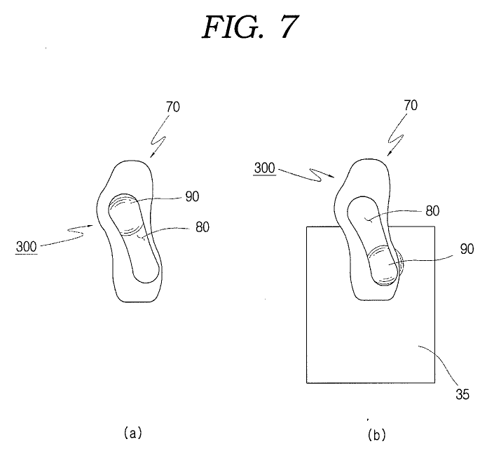

In the third embodiment, the ball paper clip's side outline's shape maintains ‘S’ which makes people imagine a female figure as shown in FIGS. 4 and 7. The guide hole 80 of the guide plate 72 is formed with curves to emphasize softness. Preferably, the guide hole 80 is formed to decline toward one side from the upper guide's center axis such that one-side surface of the clip ball 90 can protrude to the outside of the clip body 10 when clamping the paper 35. The guide hole 80 is bent with curves, declining toward one side of the clip body 70's center axis. When the paper 35 is inserted into the ball paper clip 300, the clip ball 90 is lifted along the curved guide hole 80. Here, if the clip ball shakes slightly, this structure prevents the clip ball 90 from being lifted arbitrarily along the curved guide hole 80. This shape of the guide hole 80 makes it to firmly clamp papers.

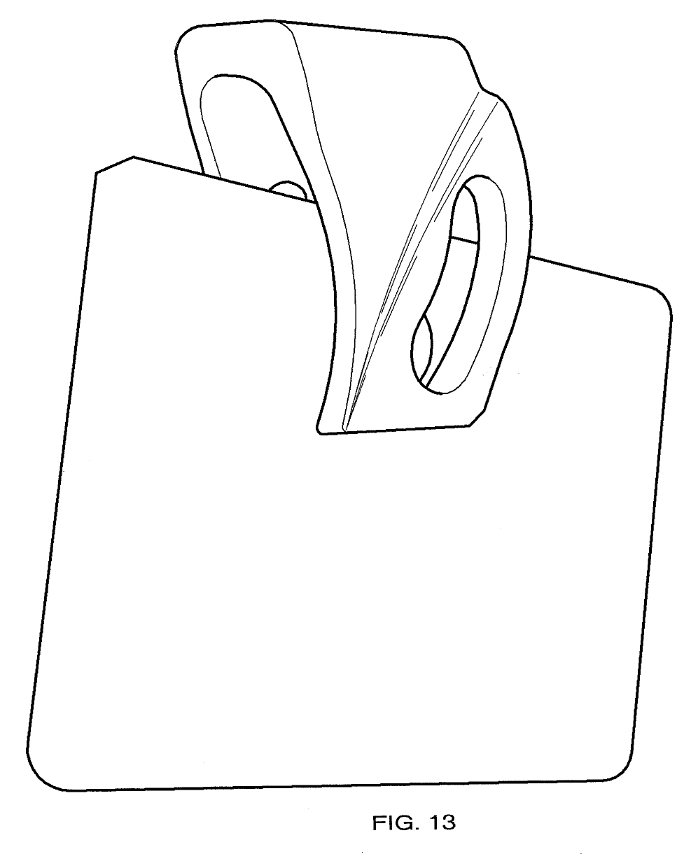

In addition, when the paper 35 is inserted into the gap portion 74, the clip ball 90 is lifted along the guide hole 80 and completely buried in the clip body 70 as shown in FIG. 7(a). However, when the clip ball 90 is rolled down at the lower part of the hole by gravity to strongly clamp the end of the papers 35, the clip ball 90 protrudes to the outside of the clip body 70 as shown in FIG. 7(b), maintaining a beautiful softly-protruding shape like a female figure in silhouette. This shape makes the ball paper clip 300 be a beautiful aesthetic product. Examples of product designs according to the third embodiment are illustrated in FIGS. 12 and 13.

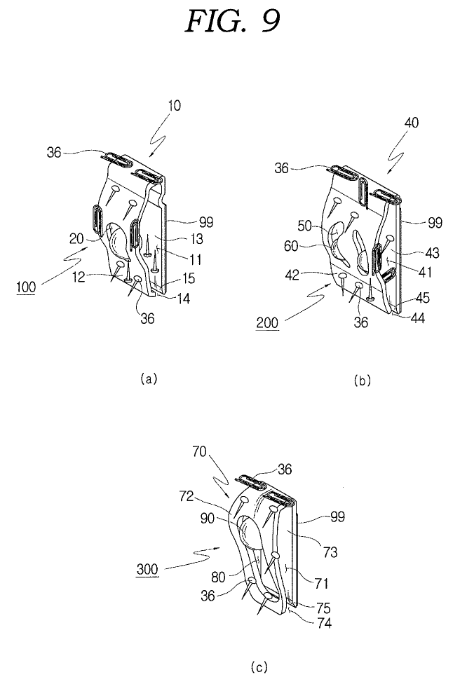

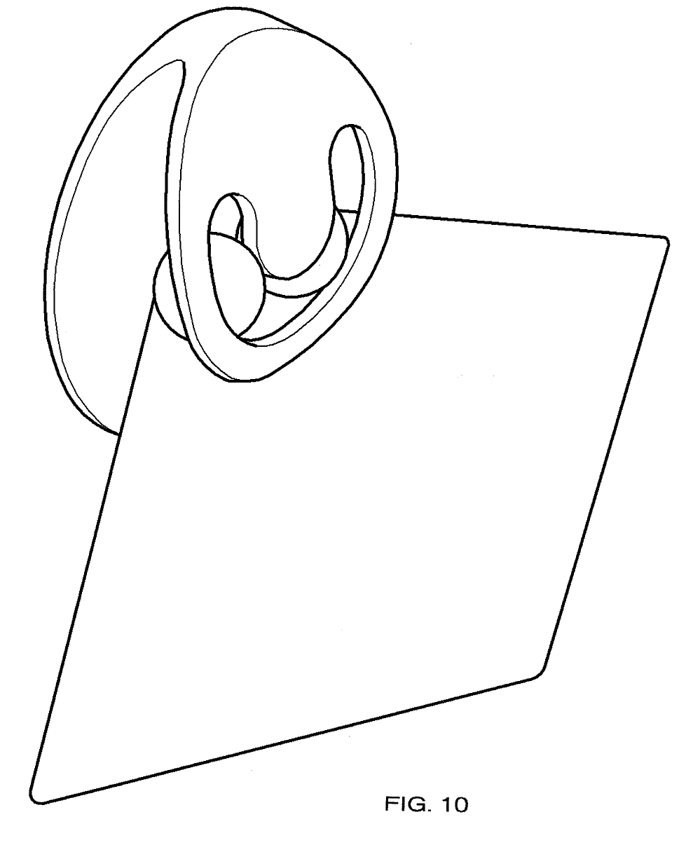

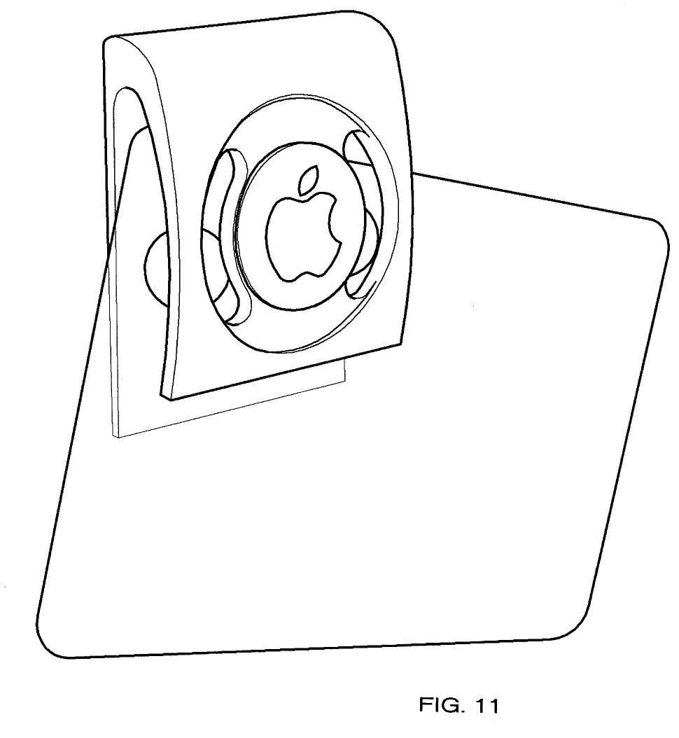

Moreover, the clip body 10, 40 or 70 may be attached to a metal surface by magnetic force through magnetic powder or magnetic coating, or the magnetic powder or magnetic coating may be put on the clip ball 30, 60 or 90. The material of the ball clip may be made of rubber for taking fast hold of the papers. The ball paper clip 100, 200 or 300 may be generally attached using magnetic force to be used by attaching the ball paper clip to the wall surface, a partition or a refrigerator. The ball paper clip 100, 200 or 300 is attached to all wall surfaces formed of a metal material, and the papers 35 are held by being inserted into the gap portion 14, 44 or 74. Further, the clip body 10, 40 or 70 and the clip ball 30, 60 or 90 may be formed to be magnetic so as to hold general wire clips or pushpins 36 as shown in FIG. 9.

Meanwhile, since a magnetic force does not operate on a titanium refrigerator door or a concrete wall surface, the present invention proposes an embodiment in which an additional double sided adhesive tape 99 is attached to a lower end of the support plate 13, 43 or 73 of the clip body 10, 40 or 70. The double sided adhesive tape 99 is attached to the rear surface of the clip body 10, 40 or 70, and attached to a wall surface after removing a release layer from the double sided adhesive tape, whereby the ball paper clip serves for a clip. Therefore, the ball paper clip 100, 200 or 300 of the present invention can be attached to all of a metal plate, a concrete wall surface and a titanium refrigerator.

According to the present invention, even if paper is clamped for a long time, the paper does not have any mark on it. There is an advantage of easy manipulation because paper is simply put in and pulled out of the ball paper clip according to the present invention.

In addition, since the present invention uses only a natural phenomenon, i.e., gravity, products can be designed in various forms. Therefore, there is an advantage of be able to design products for various purposes, such as souvenirs.

1. A ball paper clip, comprising:
a clip body including an upper guide plate and a lower support plate, the upper guide plate and the lower support plate are consist of a bifold shape having a gap made between it, the upper guide plate and the lower support plate being open at one side thereof to define a gap portion for allowing paper to be inserted therein and being connected to each other at the other side thereof, the support plate having an end taperingly cut to form a taper surface;
a guide hole bored through the guide plate of the clip body is shaped as a shape of an inverted triangle with rounded apexes; and
a clip ball fitted between the guide plate and the support plate so that an outer surface of the clip ball can be partially inserted into the guide hole.

2. A ball paper clip, comprising:
a clip body including an upper guide plate and a lower support plate, the upper guide plate and the lower support plate of a bifold with a gap made between it, the upper guide plate and the lower support plate being open at one side thereof to define a gap portion for allowing paper to be inserted therein and being connected to each other at the other side thereof, the support plate having an end taperingly cut to form a taper surface;
a pair of guide holes bored through the guide plate of the clip body vertically, the guide holes being formed in the shape of semicircles symmetrical left and right and spaced apart from each other at a certain interval; and
a pair of clip balls fitted between the guide plate and the support plate so that outer surfaces of the clip balls can be partially inserted into the guide holes, respectively.

3. A ball paper clip, comprising:
a clip body including an upper guide plate and a lower support plate, the upper guide plate and the lower support plate of a bifold with a gap made between it, the upper guide plate and the lower support plate being open at one side thereof to define a gap portion for allowing paper to be inserted therein and being connected to each other at the other side thereof, the support plate having an end taperingly cut to form a taper surface, the clip body having a planar external shape of a female figure with curves;
a guide hole bored through the guide plate of the clip body vertically is shaped as a shape of a softly-rounded curved portion and declining toward one side from the upper guide plate center's axis; and
a clip ball fitted between the guide plate and the support plate so that an outer surface of the clip ball can be partially inserted into the guide hole.

4. The ball paper clip of claim 3, wherein the guide hole into which the clip ball is fitted declines toward one side from the upper guide plate center's axis so that when the clip ball moves along the guide hole to clamp the paper, one-side surface of the clip ball protrude to the outside of the clip body.

5. The ball paper clip of claim 1, wherein one or more of magnetic powder and magnetic coating are put on the clip body so that the clip body can be attached to a metal surface by magnetic force.

6. The ball paper clip of claim 5, wherein one or more of magnetic powder and magnetic coating are formed on the clip ball so that the clip ball can be attached to a metal surface by magnetic force.

7. The ball paper clip of claim 2, wherein one or more of magnetic powder and magnetic coating are put on the clip body so that the clip body can be attached to a metal surface by magnetic force.

8. The ball paper clip of claim 7, wherein one or more of magnetic powder and magnetic coating are formed on the clip ball so that the clip ball can be attached to a metal surface by magnetic force.

9. The ball paper clip of claim 3, wherein one or more of magnetic powder and magnetic coating are put on the clip body so that the clip body can be attached to a metal surface by magnetic force.

10. The ball paper clip of claim 9, wherein one or more of magnetic powder and magnetic coating are formed on the clip ball so that the clip ball can be attached to a metal surface by magnetic force.
